(19) United States
(12) Patent Application Publication
(10) Pub. No.: US 2025/0316040 A1
(43) Pub. Date: Oct. 9, 2025

(54) METHOD AND APPARATUS FOR RENDERING VIRTUAL AVATAR, ELECTRONIC DEVICE AND STORAGE MEDIUM

(71) Applicant: Lemon Inc., Grand Cayman (KY)

(72) Inventors: Weihong ZENG, Beijing (CN); Xu WANG, Beijing (CN); Jingna SUN, Beijing (CN); Jing LIU, Los Angeles, CA (US); Shen SANG, Los Angeles, CA (US); Chunpong LAI, Los Angeles, CA (US); Peibin CHEN, Beijing (CN)

(21) Appl. No.: 18/869,808

(22) PCT Filed: May 22, 2023
(86) PCT No.: PCT/SG2023/050351

§ 371 Date: Nov. 26, 2024

(30) Foreign Application Priority Data
May 27, 2022 (CN) 202210594735.6

(51) Int. Cl. G06T 19/20; G06T 7/11; G06T 7/90; G06T 13/40

(52) U.S. Cl. CPC G06T 19/20; G06T 7/11; G06T 7/90; G06T 13/40; G06T 2207/30196; G06T 2210/16; G06T 2219/2008; G06T 2219/2012; G06T 2219/2016

(57) ABSTRACT

The embodiment of the disclosure discloses a method and apparatus for rendering a virtual avatar, an electronic device and a storage medium, and the method includes: segmenting a target image to obtain at least one first object and second objects respectively corresponding to each first object; the at least one first object respectively corresponding to at least one pre-constructed first spatial building block avatar; constructing, based on a mapping relationship between the at least one first object and the at least one first spatial building block avatar respectively corresponding to the at least one first object, second spatial building block avatars of second objects respectively corresponding to each first object; and rendering each of the first spatial building block avatars and each of the second spatial building block avatars.

### CROSS-REFERENCE TO RELATED APPLICATIONS

This is a national stage application based on International Patent Application No. PCT/SG2023/050351, filed May 22, 2023, which claims priority to Chinese Patent Application No. 202210594735.6 filed on May 27, 2022, the disclosures of which are incorporated herein by reference in their entireties.

### FIELD

The embodiment of the present disclosure relates to the technical field of computers, in particular, to rendering method and apparatus for rendering a virtual avatar, an electronic device and a storage medium.

### BACKGROUND

In the related art, a method for rendering a virtual avatar generally includes: analyzing an attribute feature of a real object, and obtaining a virtual avatar corresponding to the attribute feature from a predetermined library by matching and then rending the virtual avatar. The deficiencies of the related art include at least: the presentation effect of the virtual avatar is limited by the setting of the predetermined library, resulting in that the virtual avatar cannot better represent the current real object.

### SUMMARY

The embodiment of the present disclosure provides a method and apparatus for rendering a virtual avatar, an electronic device, and a storage medium, which can avoid being limited to the setting of a predetermined library, and make the virtual avatar better represent the current real object.

According to a first aspect, an embodiment of the present disclosure provides a method for rendering a virtual avatar, including: segmenting a target image to obtain at least one first object and a second object corresponding to each first object; the at least one first object respectively corresponding to at least one pre-constructed first spatial building block avatar; constructing, based on a mapping relationship between the at least one first object and the at least one first spatial building block avatar respectively corresponding to the at least one first object, a second spatial building block avatar of a second object respectively corresponding to each first object; and rendering each of the first spatial building block avatars and each of the second spatial building block avatars.

According to a second aspect, an embodiment of the present disclosure further provides an apparatus for rendering a virtual avatar, including: a segmenting module configured to segment a target image to obtain at least one first object and a second object corresponding to each first object; the at least one first object respectively corresponding to at least one pre-constructed first spatial building block avatar; a constructing module, configured to construct, based on a mapping relationship between the at least one first object and the at least one first spatial building block avatar respectively corresponding to the at least one first object, a second spatial building block avatar of a second object respectively corresponding to each first object; and a rendering module, configured to render each of the first spatial building block avatars and each of the second spatial building block avatars.

According to a third aspect, an embodiment of the present disclosure further provides an electronic device, including: one or more processors; a storage device, configured to store at least one program, when executed by the at least one processor, the at least one program causes the at least one processor to implement a method for rendering a virtual avatar according to any one of the embodiments of the present disclosure.

According to a fourth aspect, an embodiment of the present disclosure further provides a storage medium including computer executable instructions that, when executed by a computer processor, are configured to perform to perform the method for rendering a virtual avatar according to any one of the embodiments of the present disclosure.

### BRIEF DESCRIPTION OF DRAWINGS

Throughout the drawings, the same or similar reference numbers refer to the same or similar elements. It shall be understood that the drawings are schematic, and components and elements are not necessarily drawn to scale.

FIG. 1 is a schematic flowchart illustrating a method for rendering a virtual avatar according to an embodiment of the present disclosure;

FIG. 2 is a schematic diagram illustrating a process for rendering a building block avatar in a method for rendering a virtual avatar according to an embodiment of the present disclosure;

FIG. 3 is a schematic flowchart illustrating another method for rendering a virtual avatar according to an embodiment of the present disclosure;

FIG. 4 is a schematic structural diagram of an apparatus for rendering a virtual avatar according to an embodiment of the present disclosure;

FIG. 5 is a schematic structural diagram of an electronic device according to an embodiment of the present disclosure.

### DETAILED DESCRIPTION

Embodiments of the present disclosure will be described below with reference to the accompanying drawings. While certain embodiments of the present disclosure are shown in the drawings, it should be understood that the present disclosure may be implemented in various forms. It shall be understood that the drawings and embodiments of the present disclosure are described for exemplary purposes only.

It shall be understood that the steps recited in the method embodiments of the present disclosure may be performed in different orders, and/or in parallel. Further, the method embodiments may include additional steps and/or performing of the illustrated steps may be omitted.

The term “comprising” and its variations as used herein are non-exclusive inclusion, i.e. “including but not limited to”. The term “based on” means “at least partially based on”. The term “one embodiment” means “at least one embodiment”; the term “another embodiment” means “at least one additional embodiment”; and the term “some embodiments” means “at least some embodiments”. Relevant definitions of other terms will be given in the following description.

It should be noted that the concepts of “first” and “second” mentioned in this disclosure are only used to distinguish different devices, modules, or units, but are not used to limit the order or interdependence of the functions performed by these devices, modules, or units.

It should be noted that the modifications of “one” and “a plurality of” mentioned in this disclosure are illustrative but not limiting. Those skilled in the art should understand that unless otherwise indicated in the context, they should be understood as “one or more”.

It will be appreciated that, before using the technical solutions disclosed in the various embodiments of the present disclosure, the user shall be informed of the type, usage scope, and usage scenario of the personal information involved in this disclosure in an appropriate manner and the user's authorization shall be obtained, in accordance with relevant laws and regulations.

It may be understood that the data involved in the technical solution (including but not limited to the data itself, the acquisition or use of the data) should follow the requirements of the corresponding laws and regulations and related regulations.

FIG. 1 is a schematic flowchart illustrating a method for rendering a virtual avatar according to an embodiment of the present disclosure. The embodiment of the present disclosure is suitable for a situation in which the virtual building block avatar is rendered. The method may be performed by an apparatus for rendering a virtual avatar, and the apparatus may be implemented in a form of software and/or hardware, and the apparatus may be configured in an electronic device, for example, configured in a mobile phone and a computer.

As shown in FIG. 1, the method for rendering a virtual avatar provided in this embodiment may include the following steps.

At S110, a target image is segmented to obtain at least one first object and a second object corresponding to each first object; and the at least one first object respectively corresponds to at least one pre-constructed first spatial building block avatar.

In the embodiments of the present disclosure, the target image may be, for example, an image obtained by shooting after a shooting operation input by a user is received on the shooting interface; for another example, the target image may be an image read from a memory after an operation for allowing reading from storage input by the user is received on an image loading interface, etc. The target image may include a real object, and the real object may be, for example, an object such as a person, an animal, and a plant in reality. In the embodiment of the present disclosure, a virtual building block avatar for the real object can be constructed, and the virtual building block avatar is rendered.

The first object and the second object may be considered as local objects belonging to a real object. The real object in the target image may be segmented based on an open-source segmentation model to obtain at least one first object and second objects respectively corresponding to each first object.

Taking a character object as an example, the first object may include, for example, a face object, a torso object, and a limb object. The first spatial building block avatar corresponding to each first object may be considered as a three-dimensional building block avatar corresponding to each first object, and each three-dimensional building block avatar may be composed of at least one building block. For example, when the first object is a face object, the first spatial building block avatar corresponding to the first object may be a three-dimensional building block avatar composed of 8×8×8 three-dimensional building blocks having a length, a width, and a height respectively. By pre-constructing the at least one first spatial building block avatar respectively corresponding to the at least one first object, it can be assured that the size of the rendered virtual building block avatar can be uniform under the condition that an area proportion of the at least one first object in the image is different, so that the stability of the rendering effect can be ensured.

For each first object, there may be at least one second object corresponding thereto. The correspondence between the second object and the first object may be understood as a reference relationship for constructing a virtual building block avatar, that is, when a second spatial building block avatar of the second object is constructed, the first spatial building block avatar of the corresponding first object may be referenced.

For example, when the first object is a face object, the second object corresponding to the first object may include a facial feature object, a hair object, a headwear object, and the like; when the first object is a torso object, the second object corresponding to the first object may include a top clothing object, a jewelry object, and the like; when the first object is a limb object, the second object corresponding to the first object may include a sleeve object, a glove object, and a pants object. The first object and the corresponding second object above are merely illustrative examples, and different first objects and second objects corresponding to the first objects may be obtained by segmenting different real objects.

At S120, a second spatial building block avatar of a second object corresponding to each first object is constructed based on a mapping relationship between the at least one first object and the corresponding at least one first spatial building block avatar.

Since the first object is a two-dimensional image and the first spatial building block avatar is a three-dimensional image, the first spatial building block avatar may be adjusted to a target angle of view according to an orientation of the first object in the target image, so that the two-dimensional image of the first spatial building block avatar at the target angle of view corresponds to the first object. It may be considered that the mapping relationship between the first objects and the first building block avatars includes a mapping relationship between the first objects and the two-dimensional images of the first spatial building block avatar at the target angle of view.

For example, the mapping relationship between the first objects and the two-dimensional images of the first spatial building block avatar at the target angle of view includes at least one of the following: a size mapping relationship, an area mapping relationship, a shape mapping relationship, and the like. The second spatial building block avatar of the second object may be considered as a three-dimensional building block avatar corresponding to the second object, and the three-dimensional building block avatar may also be composed of at least one three-dimensional building block.

Constructing, according to the mapping relationship between the first objects and the corresponding first spatial building block avatars, a second spatial building block avatar of a second object corresponding to the first object including at least one of the following: determining, according to a size mapping relationship and a size of the second object corresponding to the first object in each dimension, the number of building blocks of the second spatial building block avatar in each dimension at the target angle of view; determining, according to the area mapping relationship and an area of the second object corresponding to the first object, an area of the second spatial building block avatar formed by the building blocks at the target angle of view; and determining, according to the shape mapping relationship and a shape of the second object corresponding to the first object, a shape of the second spatial building block avatar formed by the building blocks at the target angle of view. In addition, a manner of constructing the second spatial building block avatar according to other types of mapping relationships may also be applied to the embodiments of the present disclosure.

Since for different first objects, the mapping relationships between the first objects and the corresponding first spatial building blocks may be different, when constructing the second spatial building block avatar of the second object by referring the mapping relationship between the corresponding first object and the first spatial building block avatar, the coordination between the second object and the corresponding first object can be ensured.

In the embodiment of the present disclosure, a virtual building block avatar of a second object corresponding to the first object is constructed according to the segmentation result and the pre-constructed mapping relationship between first objects and first spatial building block avatars, thus image characteristics of the second object can be finely reflected, and it is possible to realize personalized and highly similar virtual avatar construction. In this construction process, steps of analyzing attribute features and matching with a predetermined library can be omitted, and the construction process will not be limited by the settings of the predetermined library, and thus the virtual avatar can better represent the current real object.

At S130, each of the first spatial building block avatars and each of the second spatial building block avatars are rendered.

Rendering the first spatial building block avatar and the second spatial building block avatar may include: determining coordinates of vertices of each building block in the first spatial building block avatar and the second spatial building block avatar; and rendering each building block according to the coordinates of the vertices of each building block, so that a virtual building block avatar composed of the first spatial building block avatar and the second spatial building block avatar can be shown in an interface.

The process of rendering the building block may be a static rendering process or a dynamic rendering process. The static rendering process can be considered as a process of rendering all building blocks almost synchronously to an interface, so that the interface can be presented with an effect of switching the virtual building block avatar from nothing to something. The dynamic rendering process may be considered as a process of sequentially rendering all building blocks to an interface, and the interface may be presented with an animation effect about a process of constructing the virtual building block avatar.

In some optional implementations, rendering the first spatial building block avatar and the second spatial building block avatar includes: dynamically building building blocks in the first spatial building block avatar and the second spatial building block avatar based on a predetermined building sequence.

The predetermined building sequence may be a sequence in simulating a real building block building process, for example, a building sequence from bottom to top; or may include a building sequence capable of presenting other effects, for example, from center to around, from center to middle, from left to right, or from right to left. In a process of dynamic building according to a building sequence, an action effect can also be added for the building blocks, so that the interestingness is improved. For example, when building blocks from bottom to top, an action falling from top to bottom may be added to the building blocks.

If each of the first spatial building block avatar is used as an entirety, and each of the second spatial building block avatar is used as an entirety, dynamically building the first spatial building block avatar and the second spatial building block avatar based on a predetermined building sequence may include: cyclically determining a current to-be-built entirety according to a predetermined building sequence; building current to-be-built entirety according to the building sequence; and determining the next to-be-constructed entirety when the building of the current to-be-built entirety is completed, until building of all the entireties is completed.

If an entire virtual building block avatar constituted of all the first spatial building block avatars and all the second spatial building block avatars is used as an entirety, dynamically building the first spatial building block avatar and the second spatial building block avatar based on a predetermined building sequence may include: cyclically determining and rendering current to-be-built building blocks according to a predetermined building sequence until the virtual building block avatar is built.

In these alternative implementations, by gradually rendering the building blocks in the predetermined sequence, the building process of the virtual building block avatar can be shown, the prop play can be enriched, the interest is improved, and the user experience can be improved.

In addition, when both the first object and the second object in the target image are relatively complete, the integrity of the virtual building block avatar is higher, and the virtual building block avatar can be viewed at different angle of views. In this case, the dynamic building process may further include: rotating and presenting the process of the dynamic building based on a predetermined rotation parameter. The predetermined rotation parameter may include parameters such as a rotation direction and an angular velocity. By presenting the building process while rotating based on the rotation parameters during the dynamic building of the virtual block image, an all-around dynamic building presentation can be achieved, and the user experience can be improved.

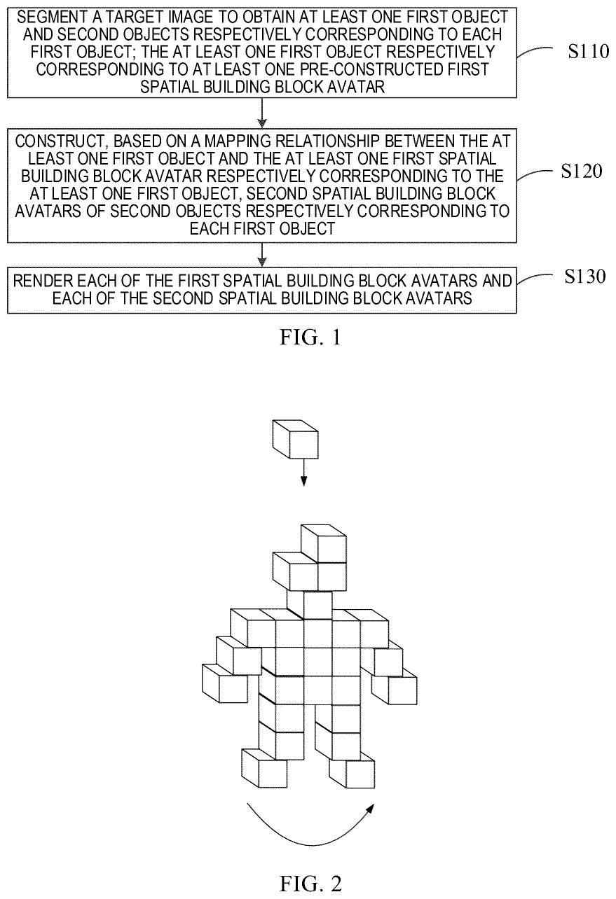

For example, FIG. 2 is a schematic diagram illustrating a rendering process for a building block avatar in a method for rendering a virtual avatar according to an embodiment of the present disclosure. Referring to FIG. 2, a virtual building block avatar of a human body can be dynamically built according to a building sequence from bottom to top. In addition, the virtual building block avatar may be a building block avatar of a human body, or may be a building block avatar of an animal or a plant. In the building process, the to-be-built building block can be added with a falling action from top to bottom. Moreover, by presenting the building process while rotating the same, the interest in rendering the virtual building block avatar is improved, and the user experience can be improved.

According to the technical solution of the embodiment of the present disclosure, the target image is segmented to obtain respective first objects and second objects corresponding to respective first objects; each first object corresponds to each pre-constructed first spatial building block avatar; according to the mapping relationship between each first object and each corresponding first spatial building block avatar, a second spatial building block avatar of a second object corresponding to each first object is constructed; and the first spatial building block avatar and the second spatial building block avatar are rendered. According to the segmentation result and the pre-constructed mapping relationship between the first objects and the first spatial building block avatars, the spatial building block avatar of the second object can be constructed in a personalized manner, which can avoid being restricted to the settings of the preset library, and thus the virtual avatar better represents the current real object.

The embodiments of the present disclosure may be combined with various optional solutions in the method for rendering a virtual avatar provided in the foregoing embodiments. According to the method for rendering a virtual avatar provided in this embodiment, the construction of the second spatial building block avatar is described. The second spatial building block avatar can be constructed according to a grid graph by griding the second object to obtain the grid graph.

In the embodiment of the present disclosure, constructing, based on the mapping relationship between respective first objects and the corresponding respective building block avatars, the second spatial building block avatars of the second objects corresponding to respective first objects may include: for each of the first objects, determining a sliding window and a step size based on a mapping relationship between a pixel size of the first object and the number of building blocks in the first spatial building block avatar corresponding to the first object; determining a grid graph of a second object by sliding on the second object corresponding to the first object using the sliding window and the step size; and constructing the second spatial building block avatar of the second object based on the grid graph.

The mapping relationship between the pixel size of the first object and the number of building blocks in the corresponding first spatial building block avatar may refer to a proportional relationship between the number of pixels of the first object in a predetermined dimension and the number of building blocks in the predetermined dimension in a two-dimensional image of the first spatial building block avatar at the target angle of view.

Determining the sliding window and the step length according to the mapping relationship may include: determining the number of pixels corresponding to each building block in a predetermined dimension (which may be simply referred to as the number of unit pixels) according to the proportional relationship, and determining the size and step of the sliding window in the predetermined dimension according to the number of unit pixels. The sizes of the sliding window in the length and width dimensions may be different. In this case, the sliding window is a rectangular box. In addition, the sliding window may also be a square box, and a size in the predetermined dimension may be used as a side length of the square box.

The size of the sliding window in the predetermined dimension and the step size are determined according to the number of unit pixels, for example, the number of unit pixels may be directly used as the size of the sliding window in the above dimension and the step size; for another example, an arithmetic operation may be performed on the number of unit pixels (for example, by a division operation), and the arithmetic operation result is used as the size of the sliding window in the above dimension and the step size. When the division operation is performed, in order to make the virtual building block avatar corresponding to the second object more detailed, the divisor may be greater than 1; meanwhile, to ensure that the virtual avatar has a building block effect, the divisor is not excessively large, for example, it may be ensured that the operation result is above 2.

The step of determining the grid graph of the second object may include: determining a sliding range; the range may be a rectangular box including the second object, and in order to ensure the efficiency for generating the grid graph, the rectangular box may be a minimum rectangular box including the second object. In the sliding range, the sliding window slides along a predetermined dimension according to a step size, where when the sliding window is a square, the sliding window may slide along any dimension. In a sliding process, when the proportion of pixels belonging to the second object in the sliding window is greater than a predetermined proportion, an area inside the sliding window may be used as a grid pixel of the second object, until the sliding is completed and a pixelized image of the second object is obtained, and the pixelized image may be referred to as a grid graph. It may be understood that each grid in the grid graph may not be limited to a square grid, for example, it may also be a rectangular grid.

Constructing the second spatial building block avatar according to the grid graph may include: assigning a size in depth direction to the two-dimensional grid in the grid graph to obtain a corresponding three-dimensional cuboid; setting a building block texture for the outer surface of each three-dimensional cuboid to obtain a building block; and splicing the building blocks to obtain a second spatial building block avatar.

Exemplarily, it is assumed that the first object is a face object, the second object is a hair object; the predetermined dimension is a height and the height of the face is h pixels, and the height of the corresponding first spatial building block avatar is 8 building blocks. Then, the step of constructing the second spatial building block avatar of the hair object may include:

First, the mapping relationship between the pixel size of the first object and the number of building blocks in the corresponding first spatial building block avatar may be determined as h: 8. In addition, h/8 may be used as a size and step size of the square sliding window.

Then, a sliding range including the hair object may be determined, and the sliding window slides in the sliding range from left to right, from top to bottom, etc., to obtain a grid image of the hair object.

Finally, a cuboid corresponding to each grid in the grid graph is determined; a building block texture is set on the outer surface of each cuboid to obtain a building block; and a second spatial building block avatar of the hair object is obtained by splicing building blocks.

The above virtual building block avatar for constructing the hair object is merely an exemplary description, and when the first object is a face object, the second spatial building block avatars of the second objects corresponding to the eyebrows, eyes, nose, mouth, beard, hair accessory, glasses and the like may be constructed in the same manner. When the first object is an object such as a torso or a limb, the second spatial building block avatar of the corresponding second object may also be constructed in the foregoing manner. Therefore, the virtual avatar construction of different real objects can be realized, and the user experience is improved.

According to the technical solution of the embodiment of the present disclosure, the construction of the second spatial building block avatar is described. The second spatial building block avatar can be constructed according to the grid graph by griding the second object. The method for rendering the virtual avatar provided by this embodiment of the present disclosure and the method for rendering the virtual avatar provided in the above embodiments belong to the same idea, technical details not described in detail in this embodiment may refer to the foregoing embodiments, and the same technical features have the same beneficial effects in this embodiment and the foregoing embodiments.

This embodiment of the present disclosure may be combined with various optional solutions in the method for rendering a virtual avatar provided in the foregoing embodiments. According to the method for rendering a c provided by this embodiment, a strategy for building the virtual avatar while rendering the virtual avatar is provided, that is, after a grid graph is determined, a current to-be-constructed building block is determined according to a predetermined building sequence, and if the building block belongs to a to-be-constructed second spatial building block avatar, the building block is constructed and rendered in real time. Therefore, there is no need to construct the building block avatar in advance and then render the building block avatar, the effect of building the virtual avatar while rendering the virtual avatar can be achieved, which reduces the waiting time of the user, and the experience is improved.

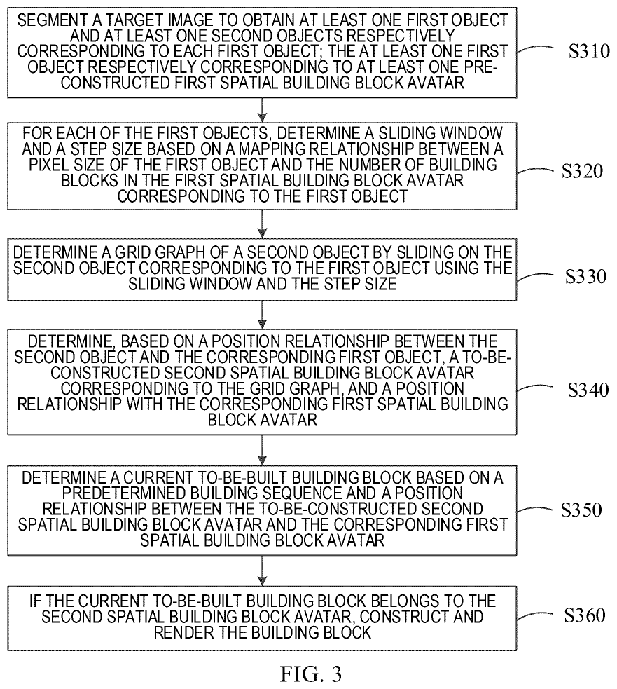

FIG. 3 is a schematic flowchart illustrating another method for rendering a virtual avatar provided in the embodiment of the present disclosure. As shown in FIG. 3, the method for rendering a virtual avatar provided in this embodiment may include the following steps.

At S310, the target image is segmented to at least one first object and second objects respectively corresponding to each first object; the at least one first object respectively corresponds to at least one pre-constructed first spatial building block avatar.

At S320, for each of the first objects, a sliding window and a step size are determined based on a mapping relationship between a pixel size of the first object and the number of building blocks in the first spatial building block avatar corresponding to the first object.

At S330, a grid graph of a second object is determined by sliding on the second object corresponding to the first object using the sliding window and the step size.

At S340, based on a position relationship between the second object and the corresponding first object, a to-be-constructed second spatial building block avatar corresponding to the grid graph and a position relationship with the corresponding first spatial building block avatar are determined.

The position relationship between the second object and the corresponding first object may include a position relationship between a feature point of the second object and a corresponding feature point in the first object.

The grid graph may be considered as a two-dimensional image of the second spatial building block avatar at the target angle of view. When a depth value is not assigned to the grids in the grid graph, it may be considered that the second spatial building block avatar is not yet constructed, but at this time, the image of the to-be-constructed second spatial building block avatar at the target angle of view may be determined. The position relationship between the to-be-constructed second spatial building block avatar and the first spatial building block avatar may be considered as a position relationship between a grid graph of the second spatial building block avatar at the target angle of view and a grid graph of the first spatial building block avatar at the target angle of view.

Determining a position relationship between the second spatial building block avatar and the corresponding first spatial building block avatar according to the position relationship between the second object and the corresponding first object, may include: determining a position relationship between a grid graph of the second spatial building block avatar at the target angle of view and a grid graph of the first spatial building block avatar at the target view angle according to a position relationship between a feature point of the second object and a corresponding feature point of the first object. For example, assuming that the first object is a face object, and the second object is a hair object; and if the lowest point of the hair object is located at a position corresponding to half of the face object, it may be determined that the lowest point of the hair grid graph may be located at half of the face square graph.

At S350, a current to-be-built building block is determined according to a predetermined building sequence and a position relationship between the to-be-constructed second spatial building block avatar and the corresponding first spatial building block avatar.

According to the position relationship between the to-be-constructed second spatial building block avatar and the corresponding first spatial building block avatar, the overall grid graph of the entire virtual building block avatar, formed by all the first spatial building block avatars and all the second spatial building block avatars, at the target angle of view can be determined. For the predetermined building sequence, the above embodiments may be referred to. The to-be-constructed building block can be determined from the overall grid graph according to a predetermined building sequence.

At S360, if the current to-be-built building block belongs to the second spatial building block avatar, the building blocks are constructed and rendered.

If the to-be-built grid belongs to a grid graph of the second spatial building block avatar at the target angle of view, it may be considered that the to-be-built building block belongs to the second spatial building block avatar. In this case, a size of depth direction can be assigned to a grid to obtain a corresponding three-dimensional cuboid; and a building block texture is provided for the outer surface of the cuboid to obtain and render a building block.

The steps S350 and S360 are the constructing and rendering steps of the second spatial building block avatar. In addition, if the current to-be-built building block belongs to the first spatial building block avatar, since the first spatial building block avatar is already constructed in advance, the corresponding building block can be directly rendered.

According to the technical solution provided by the embodiment of the present disclosure, the strategy of rendering while building is provided, that is, the current to-be-built building block can be determined according to a predetermined building sequence after the grid graph is determined, and if the building block belongs to a to-be-constructed second spatial building block avatar, the building block is constructed and rendered in real time. Therefore, there is no need to construct the building block avatar in advance and then render the building block avatar, the effect of building the virtual avatar while rendering the virtual avatar can be achieved, which reduces the waiting time of the user, and the experience is improved. The method for rendering the virtual avatar provided by this embodiment of the present disclosure and the method for rendering the virtual avatar provided in the above embodiments belong to the same idea, technical details not described in detail in this embodiment may refer to the foregoing embodiments, and the same technical features have the same beneficial effects in this embodiment and the foregoing embodiments.

This embodiment of the present disclosure may be combined with various optional solutions in the method for rendering a virtual avatar provided in the foregoing embodiments. The method for rendering a virtual avatar provided in this embodiment supplements the details of rendering the building block.

For example, in some optional implementations, the method may further include: after obtaining respective first objects and the second objects corresponding to respective first objects, determining color information of respective first objects and the second objects corresponding to respective first objects; correspondingly, rendering the first spatial building block avatar and the second spatial building block avatar includes: rendering the first spatial building block avatar and the second spatial building block avatar according to the color information of respective first objects and the corresponding second objects.

The color information of the pixels in the first/second object may be obtained; and the color information of the first/second object is determined according to the color information of the pixels. For example, a color average value of the pixels in the first/second object may be used as the color information of the first/second object; for another example, all pixels in the first/second object may be clustered according to color information, and a color average value of pixels in a maximum cluster of the clustering result may be used as the color information of the first/second object. The color information of the first/second object is determined by cluster analysis, which can avoid the situation that the individual distorted pixels affect the color information of the real pixels due to factors such as light.

In these alternative implementations, after color analysis is performed on all the objects, color rendering may be performed on the corresponding building block avatar, so that a more vivid building block avatar may be obtained. For example, when the real object is a person object, color rendering may be performed on the corresponding virtual building block avatar according to colors of objects such as hair, skin, lips, pupils, clothing, and shoes, etc. By rendering the corresponding building block avatar in combination with color information of the objects, the consistency of the building block avatar and the real object can be improved, and the building block avatar is more vivid.

For another example, in some optional implementations, the target image includes a whole-body image, and the second object includes an clothing object; after obtaining the second objects corresponding to respective first objects, the method may further include: determining at least one of the following attribute information of the clothing object: type information and pattern information; and correspondingly, rendering the second spatial building block avatar includes: rendering the second spatial building block avatar corresponding to the clothing object based on the attribute information of the clothing object.

When the target image includes a whole-body image of a person, the whole-body building block avatar of the person may be constructed. In order to make the whole-body building block avatar more similar to the whole-body image, rendering of the virtual building block avatar of the clothing objects on the torso and the limb objects is indispensable. In this case, the first object may be a torso object and/or a limb object, and the clothing object may be used as the second objects corresponding to the first objects.

The type information of the clothing object may include a short sleeve top, a long sleeve top, a short skirt, a long skirt, shorts, pants, and the like. The pattern information of the clothing object may include a solid color, a spot, a stripe, and a grid. The attribute information such as type information and pattern information of the clothing object may be determined through an open source classification model.

In these alternative implementations, when rendering the building block avatar of the whole body, the second object may include the clothing object. At this time, the corresponding building block avatar is rendered by combining the type information and/or the pattern information of the clothing object, so that the consistency between the building block avatar and the real object can be improved, and the building block avatar is more vivid.

According to the technical solution of the embodiment of the present disclosure, the rendering details of the building block avatar are supplemented, and the corresponding building block avatar can be rendered in combination with the color information of respective objects; and/or the corresponding building block avatar can be rendered in combination with the type information and/or the pattern information of the clothing object when the second object includes the clothing object. By performing color rendering, clothing type and/or pattern rendering, and through more complete analysis of the attribute analysis and/or the color of the whole-body photo, the consistency between the building block avatar and the real object can be improved, and the building block avatar is more vivid. The method for rendering the virtual avatar provided by this embodiment of the present disclosure and the method for rendering the virtual avatar provided in the above embodiments belong to the same idea, technical details not described in detail in this embodiment may refer to the foregoing embodiments, and the same technical features have the same beneficial effects in this embodiment and the foregoing embodiments.

FIG. 4 is a schematic structural diagram illustrating an apparatus for rendering a virtual avatar according to an embodiment of the present disclosure. The embodiment of the present disclosure is applicable to the situation that the virtual building block avatar is rendered.

As shown in FIG. 4, an apparatus for rendering a virtual avatar according to an embodiment of the present disclosure may include:
a segmenting module 410, configured to segment a target image to obtain at least one first object and a second object corresponding to each first object; the at least one first object respectively corresponding to at least one pre-constructed first spatial building block avatar;
a constructing module 420, configured to construct, based on a mapping relationship between the at least one first object and the at least one first spatial building block avatar respectively corresponding to the at least one first object, a second spatial building block avatar of a second object respectively corresponding to each first object; and
a rendering module 430, configured to render each of the first spatial building block avatars and each of the second spatial building block avatars.

In some optional implementations, the constructing module 420 is configured to construct the second spatial building block avatars of the second objects corresponding to each first object in the following manner:
for each of the first objects, determining a sliding window and a step size based on a mapping relationship between a pixel size of the first object and the number of building blocks in the first spatial building block avatar corresponding to the first object;
determining a grid graph of a second object by sliding on the second object corresponding to the first object using the sliding window and the step size; and
constructing the second spatial building block avatar of the second object based on the grid graph.

In some optional implementations, the rendering module 430 is configured to render each of the first spatial building block avatars and each of the second spatial building block avatars in the following manner:

dynamically building building blocks in each of the first spatial building block avatars and building blocks in each of the second spatial building block avatars based on a predetermined building sequence.

In some optional implementations, the constructing module 420 may be further configured to determine the position relationship between the to-be-constructed second spatial building block avatar corresponding to the grid graph and the corresponding first spatial building block avatar in the following manner:

After the grid graph of the second object is determined, determining, based on a position relationship between the second object and the corresponding first object, a to-be-constructed second spatial building block avatar corresponding to the grid graph, and a position relationship with the corresponding first spatial building block avatar.

Correspondingly, the constructing module 420 may construct the second spatial building block avatar based on the following steps:
determining a current to-be-built building block according to a predetermined building sequence and a position relationship between the to-be-constructed second spatial building block avatar and the corresponding first spatial building block avatar; and if the current to-be-built building block belonging to the second spatial building block avatar, constructing a building block;
the rendering module 430 may render the second spatial building block avatar based on the following steps: rendering the constructed building block after constructing the building blocks of the second spatial building block avatar.

In some optional implementations, the rendering module 430 may be further configured to rotate and present in the following manner:
in a process of the dynamic building, the process of the dynamic building is rotated and presented according to a predetermined rotation parameter.

In some optional implementations, the rendering apparatus may further include:
a color analyzing module, configured to determine color information of respective first objects and corresponding second objects after obtaining the first objects and the second objects corresponding to respective first objects;

Correspondingly, the rendering module 430 may be configured to render the first spatial building block avatar and the second spatial building block avatar in the following manner:
rendering the first spatial building block avatars and the second spatial building block avatars according to the color information of respective first object and the corresponding second objects.

In some optional implementations, the target image includes a whole-body image, and the second object includes a clothing object.
the rendering apparatus may further include:
a clothing analyzing module configured to determine, after the second objects corresponding to respective first objects are obtained, at least one of the following attribute information of the clothing object: type information and pattern information.

Correspondingly, the rendering module 430 may be configured to render the second spatial building block avatar corresponding to the clothing object in the following manner: rendering the second spatial building block avatar corresponding to the clothing object based on the attribute information of the clothing object.

The apparatus for rendering a virtual avatar provided by the embodiments of the present disclosure may execute the method for rendering a virtual avatar provided by any embodiment of the present disclosure, which has corresponding functional modules and beneficial effects when executing the method.

It should be noted that, the units and modules included in the foregoing apparatus are only divided according to function logic, but they are not limited to the foregoing division, as long as a corresponding function can be implemented; in addition, names of the function units are merely used to facilitate mutual differentiation.

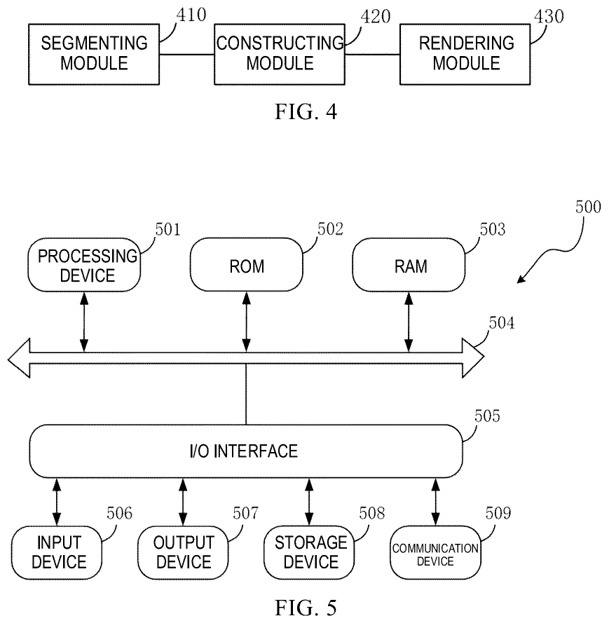

FIG. 5 is a schematic structural diagram of an electronic device (such as the terminal device or server in FIG. 5) suitable for implementing the embodiments of the present disclosure. The terminal device in the embodiments of the present disclosure may include a mobile terminal such as a mobile phone, a notebook computer, a digital broadcast receiver, a personal digital assistant (PDA), a tablet computer (PAD), a portable multimedia player (PMP), an in-vehicle terminal (for example, an in-vehicle navigation terminal), and a fixed terminal such as a digital TV, a desktop computer, or the like. The electronic device 500 shown in FIG. 5 is merely an example.

As shown in FIG. 5, the electronic device 500 may include a processing device (for example, a central processing unit, a graphics processor, etc.) 501, which may perform various appropriate actions and processing according to a program stored in a read-only memory (ROM) 502 or a program loaded into a random-access memory (RAM) 503 from a storage device 508. In the RAM 503, various programs and data required by operation of the electronic device 500 are also stored. The processing device 501, the ROM 502, and the RAM 503 are connected to each other through a bus 504. An input/output (I/O) interface 505 is also connected to the bus 504.

Typically, the following devices can be connected to I/O interface 505: input devices 506 including, for example, touch screens, touchpads, keyboards, mice, cameras, microphones, accelerometers, gyroscopes, etc.; output devices 507 including liquid crystal displays (LCDs), speakers, vibrators, etc.; storage devices 508 including magnetic tapes, hard disks, etc.; and a communication device 509. The communication device 509 may allow the electronic device 500 to communicate with other devices wirelessly or wirelessly to exchange data. Although FIG. 5 shows an electronic device 500 with various devices, it shall be understood that it is not required to implement or have all the devices shown. More or fewer devices can be implemented or provided instead.

In an embodiment, according to an embodiment of the present disclosure, the process described above with reference to the flowchart can be implemented as a computer software program. For example, an embodiment of the present disclosure includes a computer program product that includes a computer program carried on a non-transitory computer-readable medium, where the computer program includes program code for performing the method shown in the flowchart. In such an embodiment, the computer program can be downloaded and installed from a network through the communication device 509, or installed from the storage device 508, or installed from the ROM 502. When the computer program is executed by the processing device 501, the above functions defined in the method for rendering a virtual avatar of the embodiment of the present disclosure are performed.

The electronic device provided by the embodiments of the present disclosure and the method for rendering a virtual avatar provided in the foregoing embodiments belong to the same inventive concept, and technical details not described in detail in this embodiment may refer to the foregoing embodiments, and this embodiment has the same beneficial effect as the foregoing embodiments.

An embodiment of the present disclosure provides a computer storage medium having a computer program stored thereon, the program, when executed by a processor, implements the method for rendering a virtual avatar provided in the foregoing embodiments.

It should be noted that the computer-readable medium described above can be a computer-readable signal medium or a computer-readable storage medium, or combination thereof. The computer-readable storage medium can be, for example, an electrical, magnetic, optical, electromagnetic, infrared, or semiconductor system, apparatus, or device, or combination thereof. Examples of computer-readable storage media may include: an electrical connection with one or more wires, a portable computer disk, a hard disk, Random Access Memory (RAM), Read-Only Memory (ROM), an Erasable Programmable Read-Only Memory (EPROM) or flash memory (FLASH), an optical fiber, a portable Compact Disk Read-Only Memory (CD-ROM), an optical storage device, a magnetic storage device, or suitable combination thereof. In the present disclosure, a computer-readable storage medium may be tangible medium containing or storing a program that can be used by an instruction execution system, apparatus, or device, or can be used in combination with an instruction execution system, apparatus, or device. In the present disclosure, a computer-readable signal medium can include a data signal propagated in baseband or as part of a carrier wave, which carries computer-readable program code therein. Such propagated data signals may take many forms, including electromagnetic signals, optical signals, or any suitable combination thereof. A computer-readable signal medium may also be any computer-readable medium other than a computer-readable storage medium, which can send, propagate, or transmit programs for use by or in conjunction with instruction execution systems, apparatus, or devices. The program code contained on the computer-readable medium may be transmitted using any suitable medium, including: wires, optical cables, radio frequency (RF), etc., or any combination thereof.

In some embodiments, clients and servers can communicate using any currently known or future developed network protocol such as Hyper text Transfer Protocol (HTTP), and can be interconnected with any form or medium of digital data communication (such as communication networks). Examples of communication networks include Local Area Networks (“LANs”), Wide Area Networks (“WANs”), internetworks (such as the Internet), and end-to-end networks (such as ad hoc end-to-end networks), as well as currently known or future developed networks.

The computer-readable medium can be included in the electronic device, or it can exist alone without being assembled into the electronic device.

The above-mentioned computer-readable medium carries at least one programs, and when the above-mentioned at least one programs are executed by the electronic device, the electronic device: segment a target image to obtain at least one first object and second objects respectively corresponding to each first object; the at least one first object respectively corresponding to at least one pre-constructed first spatial building block avatar; construct, based on a mapping relationship between the at least one first object and the at least one first spatial building block avatar respectively corresponding to the at least one first object, second spatial building block avatars of second objects respectively corresponding to each first object; and render each of the first spatial building block avatars and each of the second spatial building block avatars.

Computer program codes for performing the operations of the present disclosure may be written in one or more programming languages or a combination thereof, including Object Oriented programming languages—such as Java, Smalltalk, C++, and also conventional procedural programming languages—such as “C” or similar programming languages. The program code may be executed entirely on the user's computer, partially executed on the user's computer, executed as a standalone software package, partially executed on the user's computer and partially on a remote computer, or entirely on a remote computer or server. In the case of involving a remote computer, the remote computer may be any kind of network—including Local Area Network (LAN) or Wide Area Network (WAN)—connected to the user's computer, or may be connected to an external computer (e.g., through an Internet service provider to connect via the Internet).

The flowcharts and block diagrams in the accompanying drawings illustrate the architecture, functions, and operations of possible implementations of the system, method, and computer program product according to various embodiments of the present disclosure. In this regard, each block in a flowchart or block diagram may represent a module, program segment, or portion of code that contains one or more executable instructions for implementing a specified logical function. It should also be noted that in some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

The units described in the embodiments of the present disclosure may be implemented by means of software or hardware. The name of the unit and module does not constitute a limitation on the unit and module itself in a certain case.

The functions described herein above can be performed at least in part by one or more hardware logic components. For example, exemplary types of hardware logic components that may be used include: Field Programmable Gate Arrays (FPGAs), Application Specific Integrated Circuits (ASICs), Application Specific Standard Parts (ASSPs), System on Chip (SOCs), Complex Programmable Logic Devices (CPLDs), and so on.

In the context of this disclosure, a machine-readable medium can be a tangible medium that may contain or store programs for use by or in conjunction with instruction execution systems, apparatuses, or devices. A machine-readable medium may be a machine-readable signal medium or a machine-readable storage medium. A machine-readable medium may include, but are not limited to, electronic, magnetic, optical, electromagnetic, infrared, or semiconductor systems, apparatuses, or devices, or any suitable combination thereof. Specific examples of the machine-readable storage medium may include electrical connections based on one or more wires, portable computer disks, hard disks, Random Access Memory (RAM), Read-Only Memory (ROM), an Erasable Programmable Read-Only Memory (EPROM) or flash memory (FLASH), an optical fiber, a portable Compact Disk Read-Only Memory (CD-ROM), optical storage devices, magnetic storage devices, or suitable combination thereof.

According to one or more embodiments of the present disclosure, [Example 1] provides a method for rendering a virtual avatar.
segmenting a target image to obtain at least one first object and second objects respectively corresponding to each first object; the at least one first object respectively corresponding to at least one pre-constructed first spatial building block avatar;
constructing, based on a mapping relationship between the at least one first object and the at least one first spatial building block avatar respectively corresponding to the at least one first object, second spatial building block avatars of second objects respectively corresponding to each first object; and
rendering each of the first spatial building block avatars and each of the second spatial building block avatars.

According to one or more embodiments of the present disclosure, [Example 2] provides a method for rendering a virtual avatar, the method further comprising:

In some optional implementations, constructing, based on the mapping relationship between the respective first objects and corresponding respective first spatial building block avatars, the second spatial building block avatars of the second objects corresponding to respective first objects includes:
for each of the first objects, determining a sliding window and a step size based on a mapping relationship between a pixel size of the first object and the number of building blocks in the first spatial building block avatar corresponding to the first object;
determining a grid graph of a second object by sliding on the second object corresponding to the first object using the sliding window and the step size; and
constructing the second spatial building block avatar of the second object based on the grid graph.

According to one or more embodiments of the present disclosure, [Example 3] provides a method for rendering a virtual avatar, further including:

In some optional implementations, rendering the first spatial building block avatars and the second spatial building block avatars includes:
dynamically building building blocks in the first spatial building block avatars and the second spatial building block avatars based on a predetermined building sequence.

According to one or more embodiments of the present disclosure, [Example 4] provides a method for rendering a virtual avatar, further including:

In some optional implementations, after determining the grid graphs of the second object, the method further includes:
determining, based on a position relationship between the second object and the corresponding first object, a to-be-constructed second spatial building block avatar corresponding to the grid graph, and a position relationship with the corresponding first spatial building block avatar;

Correspondingly, the step of constructing and rendering the second spatial building block avatar includes:
determining a current to-be-built building block according to a predetermined building sequence and a position relationship between the to-be-constructed second spatial building block avatar and the corresponding first spatial building block avatar;
in response to the current to-be-built building block belonging to the second spatial building block avatar, constructing and rendering the building block.

According to one or more embodiments of the present disclosure, [Example 5] provides a method for rendering a virtual avatar, further including:

In some optional implementations, in a process of the dynamic building, the method further includes:
rotating and presenting the process of the dynamic building based on a predetermined rotation parameter.

According to one or more embodiments of the present disclosure, [Example 6] provides a method for rendering a virtual avatar, further including:

In some optional implementations, after obtaining respective first objects and the second objects corresponding to respective first objects, the method further includes:
determining color information of respective first objects and the corresponding second objects;

Correspondingly, rendering the first spatial building block avatar and the second spatial building block avatar includes:
rendering the first spatial building block avatar and the second spatial building block avatar according to the color information of respective first objects and the corresponding second objects.

According to one or more embodiments of the present disclosure, [Example 7] provides a method for rendering a virtual avatar, further comprising:

In some optional implementations, the target image includes a whole-body image, and the second object includes a clothing object.
after obtaining the second objects corresponding to respective first objects, the method further includes: determining at least one of the following attribute information of the clothing object: type information and pattern information.

Correspondingly, rendering the second spatial building block avatar includes: rendering the second spatial building block avatar corresponding to the clothing object based on the attribute information of the clothing object.

According to one or more embodiments of the present disclosure, [Example 8] provides an apparatus for rendering a virtual avatar, including
a segmenting module, configured to segment a target image to obtain at least one first object and a second object corresponding to each first object; the at least one first object respectively corresponding to at least one pre-constructed first spatial building block avatar;
a constructing module, configured to construct, based on a mapping relationship between the at least one first object and the at least one first spatial building block avatar respectively corresponding to the at least one first object, a second spatial building block avatar of a second object respectively corresponding to each first object; and
a rendering module, configured to render each of the first spatial building block avatars and each of the second spatial building block avatars.

Further, while operations are depicted in a particular order, this should not be understood as requiring these operations to be performed in the specific order shown or to be performed sequentially. In certain environments, multitasking and parallel processing may be advantageous.

1-10. (canceled)

11. A method for rendering a virtual avatar, comprising:
segmenting a target image to obtain at least one first object and second objects respectively corresponding to each first object; the at least one first object respectively corresponding to at least one pre-constructed first spatial building block avatar;
constructing, based on a mapping relationship between the at least one first object and the at least one first spatial building block avatar respectively corresponding to the at least one first object, second spatial building block avatars of second objects respectively corresponding to each first object; and
rendering each of the first spatial building block avatars and each of the second spatial building block avatars.

12. The method of claim 11, wherein constructing, based on the mapping relationship between the at least one first object and the at least one first spatial building block avatar respectively corresponding to the at least one first object, the second spatial building block avatars of the second objects respectively corresponding to each first object comprises:
for each of the first objects, determining a sliding window and a step size based on a mapping relationship between a pixel size of the first object and the number of building blocks in the first spatial building block avatar corresponding to the first object;
determining a grid graph of a second object by sliding on the second object corresponding to the first object using the sliding window and the step size; and
constructing the second spatial building block avatar of the second object based on the grid graph.

13. The method of claim 11, wherein rendering each of the first spatial building block avatars and each of the second spatial building block avatars comprises:
dynamically building building blocks in each of the first spatial building block avatars and building blocks in each of the second spatial building block avatars based on a predetermined building sequence.

14. The method of claim 12, wherein the method further comprises: after determining the grid graphs of the second object,
determining, based on a position relationship between the second object and the corresponding first object, a to-be-constructed second spatial building block avatar corresponding to the grid graph, and a position relationship with the corresponding first spatial building block avatar;
constructing and rendering the second spatial building block avatar comprises:
determining a current to-be-built building block based on a predetermined building sequence and a position relationship between the to-be-constructed second spatial building block avatar and the corresponding first spatial building block avatar;
in response to the current to-be-built building block belonging to the second spatial building block avatar, constructing and rendering the building block.

15. The method of claim 13, wherein the method further comprises: in a process of the dynamic building,
rotating and presenting the process of the dynamic building based on a predetermined rotation parameter.

16. The method of claim 11, wherein the method further comprises: after obtaining the at least one first object and the second objects respectively corresponding to each first object,
determining color information of the at least one first object and color information of the second objects respectively corresponding to each first object;
rendering each of the first spatial building block avatars and each of the second spatial building block avatars comprises:
rendering each of the first spatial building block avatars and each of the second spatial building block avatars based on the color information of the at least one first object and the color information of the second object respectively corresponding to each first object.

17. The method of claim 11, wherein the target image comprises a whole-body image, and the second object comprises a clothing object,
the method further comprises: after obtaining the second objects respectively corresponding to each first object, determining at least one of the following attribute information of the clothing object: type information and pattern information; and
rendering the second spatial building block avatar comprises: rendering the second spatial building block avatar corresponding to the clothing object based on the attribute information of the clothing object.

18. An electronic device, comprising:
one or more processors;
a storage device, configured to store at least one program, when executed by the at least one processor, the at least one program causes the at least one processor to implement a method for rendering a virtual avatar, comprising:
segmenting a target image to obtain at least one first object and second objects respectively corresponding to each first object; the at least one first object respectively corresponding to at least one pre-constructed first spatial building block avatar;
constructing, based on a mapping relationship between the at least one first object and the at least one first spatial building block avatar respectively corresponding to the at least one first object, second spatial building block avatars of second objects respectively corresponding to each first object; and
rendering each of the first spatial building block avatars and each of the second spatial building block avatars.

19. The device of claim 18, wherein constructing, based on the mapping relationship between the at least one first object and the at least one first spatial building block avatar respectively corresponding to the at least one first object, the second spatial building block avatars of the second objects respectively corresponding to each first object comprises:
for each of the first objects, determining a sliding window and a step size based on a mapping relationship between a pixel size of the first object and the number of building blocks in the first spatial building block avatar corresponding to the first object;
determining a grid graph of a second object by sliding on the second object corresponding to the first object using the sliding window and the step size; and
constructing the second spatial building block avatar of the second object based on the grid graph.

20. The device of claim 18, wherein rendering each of the first spatial building block avatars and each of the second spatial building block avatars comprises:
dynamically building building blocks in each of the first spatial building block avatars and building blocks in each of the second spatial building block avatars based on a predetermined building sequence.

21. The device of claim 19, wherein the method further comprises: after determining the grid graphs of the second object,
determining, based on a position relationship between the second object and the corresponding first object, a to-be-constructed second spatial building block avatar corresponding to the grid graph, and a position relationship with the corresponding first spatial building block avatar;
constructing and rendering the second spatial building block avatar comprises:
determining a current to-be-built building block based on a predetermined building sequence and a position relationship between the to-be-constructed second spatial building block avatar and the corresponding first spatial building block avatar;
in response to the current to-be-built building block belonging to the second spatial building block avatar, constructing and rendering the building block.

22. The device of claim 20, wherein the method further comprises: in a process of the dynamic building,
rotating and presenting the process of the dynamic building based on a predetermined rotation parameter.

23. The device of claim 18, wherein the method further comprises: after obtaining the at least one first object and the second objects respectively corresponding to each first object,
determining color information of the at least one first object and color information of the second objects respectively corresponding to each first object;
rendering each of the first spatial building block avatars and each of the second spatial building block avatars comprises:
rendering each of the first spatial building block avatars and each of the second spatial building block avatars based on the color information of the at least one first object and the color information of the second object respectively corresponding to each first object.

24. The device of claim 18, wherein the target image comprises a whole-body image, and the second object comprises a clothing object,
the method further comprises: after obtaining the second objects respectively corresponding to each first object, determining at least one of the following attribute information of the clothing object: type information and pattern information; and
rendering the second spatial building block avatar comprises: rendering the second spatial building block avatar corresponding to the clothing object based on the attribute information of the clothing object.

25. A non-transitory computer readable storage medium comprising computer-executable instructions, wherein the computer-executable instructions, when executed by a computer processor, are configured to perform the method for rendering a virtual avatar, comprising:
segmenting a target image to obtain at least one first object and second objects respectively corresponding to each first object; the at least one first object respectively corresponding to at least one pre-constructed first spatial building block avatar;
constructing, based on a mapping relationship between the at least one first object and the at least one first spatial building block avatar respectively corresponding to the at least one first object, second spatial building block avatars of second objects respectively corresponding to each first object; and
rendering each of the first spatial building block avatars and each of the second spatial building block avatars.

26. The medium of claim 25, wherein constructing, based on the mapping relationship between the at least one first object and the at least one first spatial building block avatar respectively corresponding to the at least one first object, the second spatial building block avatars of the second objects respectively corresponding to each first object comprises:
for each of the first objects, determining a sliding window and a step size based on a mapping relationship between a pixel size of the first object and the number of building blocks in the first spatial building block avatar corresponding to the first object;
determining a grid graph of a second object by sliding on the second object corresponding to the first object using the sliding window and the step size; and
constructing the second spatial building block avatar of the second object based on the grid graph.

27. The medium of claim 25, wherein rendering each of the first spatial building block avatars and each of the second spatial building block avatars comprises:
dynamically building building blocks in each of the first spatial building block avatars and building blocks in each of the second spatial building block avatars based on a predetermined building sequence.

28. The medium of claim 26, wherein the method further comprises: after determining the grid graphs of the second object,
determining, based on a position relationship between the second object and the corresponding first object, a to-be-constructed second spatial building block avatar corresponding to the grid graph, and a position relationship with the corresponding first spatial building block avatar;
constructing and rendering the second spatial building block avatar comprises:
determining a current to-be-built building block based on a predetermined building sequence and a position relationship between the to-be-constructed second spatial building block avatar and the corresponding first spatial building block avatar;
in response to the current to-be-built building block belonging to the second spatial building block avatar, constructing and rendering the building block.

29. The medium of claim 27, wherein the method further comprises: in a process of the dynamic building,
rotating and presenting the process of the dynamic building based on a predetermined rotation parameter.

30. The medium of claim 25, wherein the method further comprises: after obtaining the at least one first object and the second objects respectively corresponding to each first object,
determining color information of the at least one first object and color information of the second objects respectively corresponding to each first object;
rendering each of the first spatial building block avatars and each of the second spatial building block avatars comprises:
rendering each of the first spatial building block avatars and each of the second spatial building block avatars based on the color information of the at least one first object and the color information of the second object respectively corresponding to each first object.
